(19) United States
(12) Patent Application Publication
(10) Pub. No.: US 2026/0154781 A1
(43) Pub. Date: Jun. 4, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Shuhei HORITA, Saitama (JP)

(73) Assignee: FUJIFILM Corporation, Tokyo (JP)

(21) Appl. No.: 19/455,764

(22) Filed: Jan. 21, 2026

Related U.S. Application Data
(63) Continuation of application No. PCT/JP2024/023107, filed on Jun. 26, 2024.

(30) Foreign Application Priority Data
Jul. 31, 2023 (JP) 2023-124889

(51) Int. Cl. G06T 3/40; G06T 7/00; G06T 7/60; G06T 11/00

(52) U.S. Cl. CPC G06T 3/40; G06T 7/0002; G06T 7/60; G06T 11/00; G06T 2200/24; G06T 2207/20212; G06T 2207/30168; G06T 2207/30184; G06T 2210/36

(57) ABSTRACT

Provided are an image processing apparatus, an image processing method, and an image processing program capable of comprehensively evaluating damage to a structure in an individual image obtained by dividing the structure into a plurality of divided regions and imaging the divided region or in a composite image of the individual images. In an image processing method using an image processing apparatus (1) including a processor (10), the image processing method by the processor includes a step of acquiring pixel positions of at least two points of a plurality of individual images obtained by imaging a subject or a composite image obtained by combining the individual images, and an actual length between the two points, and a step of performing resizing processing on the individual image or the composite image such that the number of pixels between the two points approaches a desired pixel spacing.

### CROSS-REFERENCE TO RELATED APPLICATIONS

The present application is a Continuation of PCT International Application No. PCT/JP2024/023107 filed on Jun. 26, 2024 claiming priority under 35 U.S.C § 119(a) to Japanese Patent Application No. 2023-124889 filed on Jul. 31, 2023. Each of the above applications is hereby expressly incorporated by reference, in its entirety, into the present application.

### BACKGROUND OF THE INVENTION

### 1. Field of the Invention

The present invention relates to an image processing apparatus, an image processing method, and an image processing program, and particularly relates to a technique of inspecting a structure by using a plurality of individual images obtained by dividing and imaging the structure as a subject or a composite image of the individual images.

### 2. Description of the Related Art

Structures such as a bridge, a road, a tunnel, and a dam are maintained as a base of industry and life, and play an important role in supporting comfortable life of people. Such structures are constructed using, for example, concrete or steel frames, but deteriorate over time since the structures are used by people for a long period of time. For this reason, it is necessary to inspect such structures at appropriate times to find a location where damage and deterioration have occurred, and to perform appropriate maintenance management such as replacement or repair of members.

Damage is detected from images obtained by imaging the structures to perform the inspection of such structures. However, it is difficult to include, in one image, the entire structure of a large structure such as the bridge, the road, the tunnel, and the dam.

An image processing method has been proposed in which a structure is divided into a plurality of divided regions and imaged, and images of the plurality of divided regions are connected or combined to create one image including the entire structure or a region wider than the divided region (for example, refer to JP2004-021578A).

### SUMMARY OF THE INVENTION

Incidentally, a pixel spacing (mm/pixel) of the image obtained by imaging the divided region (hereinafter, referred to as an individual image) varies due to various factors (for example, variation in imaging distance, variation in focal length, and variation in imaging angle). The variation in pixel spacing between the individual images may be a factor of distortion of a composite image in which the individual images are combined. Further, in a case where the variation in pixel spacing is present between the individual images, it is difficult to perform comprehensive evaluation while comparing damage that is contained in the plurality of individual images or damage that is present across the plurality of individual images.

One embodiment according to the present disclosed technology provides an image processing apparatus, an image processing method, and an image processing program capable of comprehensively evaluating damage to a structure in an individual image obtained by dividing the structure into a plurality of divided regions and imaging the divided region or in a composite image of the individual images.

An image processing apparatus according to a first aspect of the present invention is an image processing apparatus including a processor, in which the processor is configured to acquire pixel positions of at least two points of a plurality of individual images obtained by imaging a subject or a composite image obtained by combining the individual images, and an actual length between the two points, and perform resizing processing on the individual image or the composite image such that the number of pixels between the two points approaches a desired pixel spacing.

According to a second aspect of the present invention, in the image processing apparatus, the two points in the first aspect may be on boundaries between different surfaces that constitute the subject.

According to a third aspect of the present invention, in the image processing apparatus according to the first aspect, the processor may be configured to designate the two points in response to an instruction input from a user.

According to a fourth aspect of the present invention, in the image processing apparatus according to any one of the first to third aspects, the processor may be configured to acquire the actual length between the two points from drawing data of the subject.

According to a fifth aspect of the present invention, in the image processing apparatus according to any one of the first to third aspects, the processor may be configured to acquire the actual length between the two points from information indicating a shape and a dimension of the subject.

According to a sixth aspect of the present invention, in the image processing apparatus according to any one of the first to fifth aspects, the processor may be configured to divide the plurality of individual images into a plurality of image sets, combine the plurality of image sets to create a plurality of composite images, and perform the resizing processing on the plurality of composite images such that pixel spacings of the plurality of composite images approach the desired pixel spacing.

According to a seventh aspect of the present invention, in the image processing apparatus according to any one of the first to sixth aspects, the processor may be configured to display the plurality of composite images side by side on a display unit.

According to an eighth aspect of the present invention, in the image processing apparatus according to any one of the first to seventh aspects, the processor may be configured to detect damage to the subject from the individual image or the composite image, and draw a detection result of the damage together with the composite image.

According to a ninth aspect of the present invention, in the image processing apparatus according to the eighth aspect, the processor may be configured to display the composite image and the composite image on which the detection result of the damage is drawn, on a display unit, in a switchable manner.

According to a tenth aspect of the present invention, in the image processing apparatus according to any one of the first to ninth aspects, the processor may be configured to designate a pixel spacing of the individual image or the composite image, which has been subjected to the resizing processing, in response to an instruction input from a user.

According to an eleventh aspect of the present invention, in the image processing apparatus according to any one of the first to ninth aspects, the processor may be configured to designate a pixel spacing of the individual image or the composite image, which has been subjected to the resizing processing, based on information related to a pixel spacing of the individual image.

According to a twelfth aspect of the present invention, in the image processing apparatus according to the eleventh aspect, the processor may be configured to designate a pixel spacing of the composite image, which has been subjected to the resizing processing, based on at least one of a representative value, an average value, a maximum value, or a minimum value of the pixel spacing of the individual image.

According to a thirteenth aspect of the present invention, in the image processing apparatus according to any one of the first to twelfth aspects, the processor may be configured to output a warning in a case where a resizing magnification in the resizing processing is out of an allowable range.

According to a fourteenth aspect of the present invention, in the image processing apparatus according to any one of the first to thirteenth aspects, the processor may be configured to output a warning in a case where there is the individual image having a pixel spacing that is larger than the desired pixel spacing.

According to a fifteenth aspect of the present invention, in the image processing apparatus according to any one of the first to fourteenth aspects, the individual image may be obtained by imaging at least a part of a top surface, a side surface, or a lower surface of a tunnel as the subject.

An image processing method according to a sixteenth aspect of the present invention is an image processing method using an image processing apparatus including a processor, the image processing method by the processor including a step of acquiring pixel positions of at least two points of a plurality of individual images obtained by imaging a subject or a composite image obtained by combining the individual images, and an actual length between the two points, and a step of performing resizing processing on the individual image or the composite image such that the number of pixels between the two points approaches a desired pixel spacing.

An image processing program according to a seventeenth aspect of the present invention is an image processing program causing a computer to realize a function of acquiring pixel positions of at least two points of a plurality of individual images obtained by imaging a subject or a composite image obtained by combining the individual images, and an actual length between the two points, and a function of performing resizing processing on the individual image or the composite image such that the number of pixels between the two points approaches a desired pixel spacing.

### BRIEF DESCRIPTION OF THE DRAWINGS

FIG. 1 is a block diagram showing an image processing apparatus according to an embodiment of the present invention.

FIG. 2 is a front view of an appearance of an imaging apparatus.

FIG. 3 is a front view of an example of a structure (tunnel).

FIG. 4 is a block diagram of the imaging apparatus.

FIG. 5 is a diagram for describing an image processing function of the image processing apparatus.

FIG. 6 is a diagram for describing the image processing function of the image processing apparatus.

FIG. 7 is a diagram for describing the image processing function of the image processing apparatus.

FIG. 8 is a diagram showing a display example of composite images (composite developed images).

FIG. 9 is a diagram showing a display example of the composite images.

FIG. 10 is a flowchart showing an image processing method.

FIG. 11 is a flowchart showing a pixel spacing setting step (first example).

FIG. 12 is a flowchart showing a pixel spacing setting step (second example).

FIG. 13 is a flowchart showing an image output step.

### DESCRIPTION OF THE PREFERRED EMBODIMENTS

Hereinafter, embodiments of an image processing apparatus, an image processing method, and an image processing program according to the present invention will be described with reference to accompanying drawings.

### Image Processing Apparatus

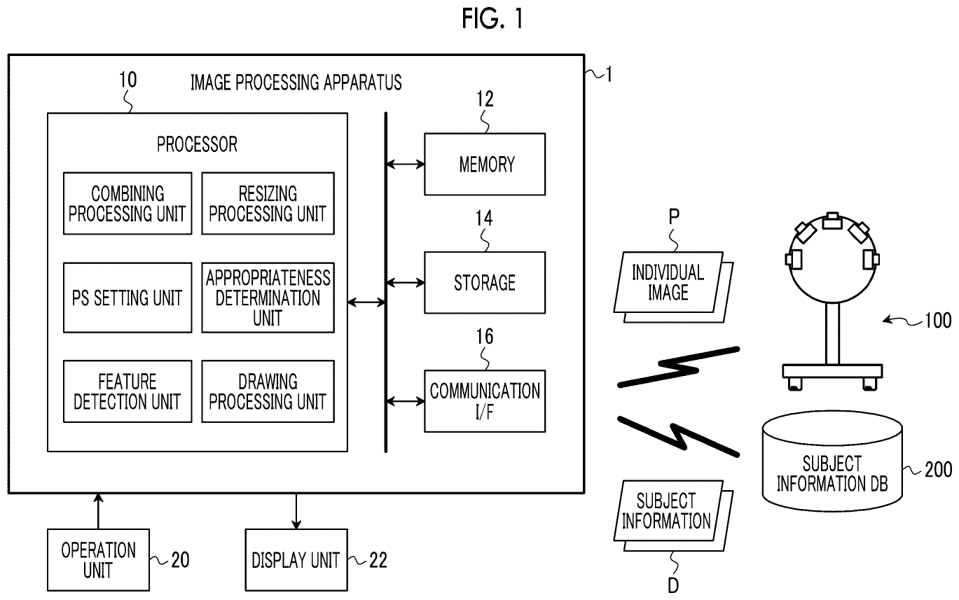

FIG. 1 is a block diagram showing an image processing apparatus according to an embodiment of the present invention.

An image processing apparatus 1 according to the present embodiment acquires, from an imaging apparatus 100, individual images P obtained by imaging a plurality of divided regions of a structure OBJ to be inspected, and performs image processing (for example, resizing processing) on the individual image P or a composite image obtained by combining a plurality of individual images P. With the image processing, it is possible to provide, to a user, an image with a pixel spacing suitable for the inspection (image diagnosis) of damage to the structure OBJ, and it is possible to support comprehensive evaluation of the damage to the structure OBJ.

As shown in FIG. 1, the image processing apparatus 1 according to the present embodiment includes a processor 10, a memory 12, a storage 14, and a communication interface (communication I/F) 16. The image processing apparatus 1 may be, for example, a general-purpose computer such as a personal computer or a workstation, or a tablet terminal.

The processor 10 is a device that controls an operation of each unit of the image processing apparatus 1, and includes, for example, a central processing unit (CPU) or a graphics processing unit (GPU). The processor 10 can transmit and receive a control signal and data to and from each unit of the image processing apparatus 1 via a bus. The processor 10 receives an instruction input from the user via an operation unit 20, and transmits the control signal corresponding to the instruction input to each unit of the image processing apparatus 1 via the bus to control the operation of each unit.

The memory 12 includes a random access memory (RAM) used as a work area for various types of calculation, or a video random access memory (VRAM) used as an area for temporarily storing image data output to a display unit 22.

The operation unit 20 is an input device that receives the instruction input from the user, and includes a keyboard for inputting characters and the like, and a pointing device (for example, mouse, or trackball) for operating a graphical user interface (GUI), such as a pointer and an icon, displayed on the display unit 22. A touch panel may be provided on a surface of the display unit 22, as the operation unit 20, instead of or in addition to the keyboard and the pointing device.

The display unit 22 is a device that displays an image. For example, a liquid crystal monitor can be used as the display unit 22.

The storage 14 stores various types of data including a control program and an image processing program for various types of calculation, and the individual image P (for example, visible light image or infrared image) obtained by imaging the structure OBJ to be inspected. For example, a device including a magnetic disk such as a hard disk drive (HDD) or a device including a flash memory such as an embedded multi media card (eMMC) or a solid state drive (SSD) can be used as the storage 14.

The communication I/F 16 is a device that performs communication with an external device including the imaging apparatus 100 and a subject information DB 200. As a method of transmitting and receiving data between the image processing apparatus 1 and the external device, wired communication or wireless communication (for example, local area network (LAN), wide area network (WAN), or Internet connection) via a network can be used.

The image processing apparatus 1 can receive, from the imaging apparatus 100, an input of the individual image P via the communication I/F 16. A method of inputting the individual image P to the image processing apparatus 1 is not limited to the communication via the network. For example, a universal serial bus (USB) cable, Bluetooth (registered trademark), or infrared communication may be used. Further, the individual image P may be stored in a recording medium (for example, USB memory or SD (registered trademark) memory card) that is attachable to and detachable from the image processing apparatus 1, and the input of the individual image P may be received from the imaging apparatus 100 via the recording medium.

### Imaging Apparatus

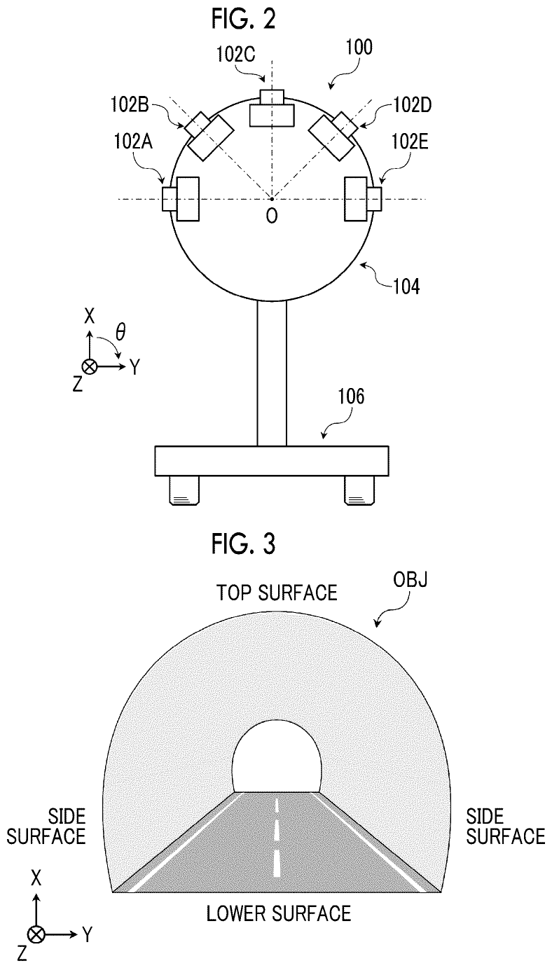

FIG. 2 is a front view of an appearance of the imaging apparatus 100.

The imaging apparatus 100 includes cameras 102A to 102E. The cameras 102A to 102E are devices that capture images of the structure OBJ to be inspected, for example, with visible light or infrared light, and include an imaging element such as a charge coupled device (CCD) or a complementary metal oxide semiconductor (CMOS). The number and disposition of the cameras 102A to 102E can be changed according to a type, structure, shape, and size of the structure OBJ to be inspected.

In the following, an example will be described in which an inner peripheral surface of a tunnel shown in FIG. 3 is inspected, as the structure OBJ to be inspected. The imaging apparatus 100 can image the inner peripheral surface of the tunnel while moving inside the tunnel along a depth direction. In the following, a movement direction (forward and backward direction) of the imaging apparatus 100 is referred to as a Z direction, and an up-down direction and a left-right direction of the imaging apparatus 100 are referred to as an X direction and a Y direction, respectively. Thus, the X, Y, and Z directions correspond to a height direction, the left-right direction, and the depth direction of the tunnel, respectively.

In a case where the inner peripheral surface of the tunnel is inspected, the cameras 102A to 102E are disposed, for example, in a curved shape corresponding to or following a shape of the inner peripheral surface of the tunnel, as shown in FIG. 2. In the following, for simplification of description, an example will be described in which the five cameras 102A to 102E are attached at equal spacings (spacing of 45°) on an arc at equal distances from a reference position (center) O of a camera attachment member 104.

As shown by a one-dot chain line in FIG. 2, optical axes of the cameras 102A to 102E are disposed radially from the center O of the camera attachment member 104, and imaging directions of the cameras 102A to 102E are different from each other. That is, as shown in FIG. 2, the cameras 102A and 102E are disposed laterally (toward −Y side and +Y side, respectively), and can respectively image left-right side surfaces of the tunnel or divided regions including the left-right side surfaces and a part of a lower surface of the tunnel. Further, the camera 102C is disposed to face directly above (+X side), and can image a top surface of the tunnel or a divided region including the top surface and a part of the side surface. The cameras 102B and 102D can image a divided region between the divided regions imaged by the cameras 102A and 102C and a divided region between the divided regions imaged by the cameras 102E and 102C. The cameras 102A to 102E are preferably disposed such that adjacent images in an inner peripheral direction, among images captured by the cameras 102A to 102E, have overlapping regions. With the individual images P captured by using the cameras 102A to 102E disposed as described above, it is possible to cover the entire inner peripheral direction of the tunnel.

As shown in FIG. 2, the camera attachment member 104 is attached to a support column on a carriage 106, and the imaging apparatus 100 can be moved by the carriage 106 along the depth direction of the tunnel. A movement distance of the imaging apparatus 100 is preferably adjusted such that adjacent images in the depth direction, among the individual images P respectively captured by the cameras 102A to 102E, have overlapping regions. With repeat imaging of the inner peripheral surface of the tunnel while moving the imaging apparatus 100 as described above, it is possible to acquire the individual images P along the depth direction of the tunnel and covering the entire inner peripheral direction of the tunnel.

In the example shown in FIG. 2, the five cameras 102A to 102E are disposed in an arc shape, but the present invention is not limited thereto. For example, one camera may be rotatably attached around a Z-axis (θ direction) and may be rotated to perform imaging each time the imaging apparatus 100 is moved in the Z direction to acquire the individual images P covering the entire inner peripheral surface of the tunnel. Further, the cameras 102A to 102E may be disposed, for example, in a shape (for example, shape approximating or similar to the inner peripheral surface of the tunnel) corresponding to the shape of the inner peripheral surface of the tunnel (drawing data).

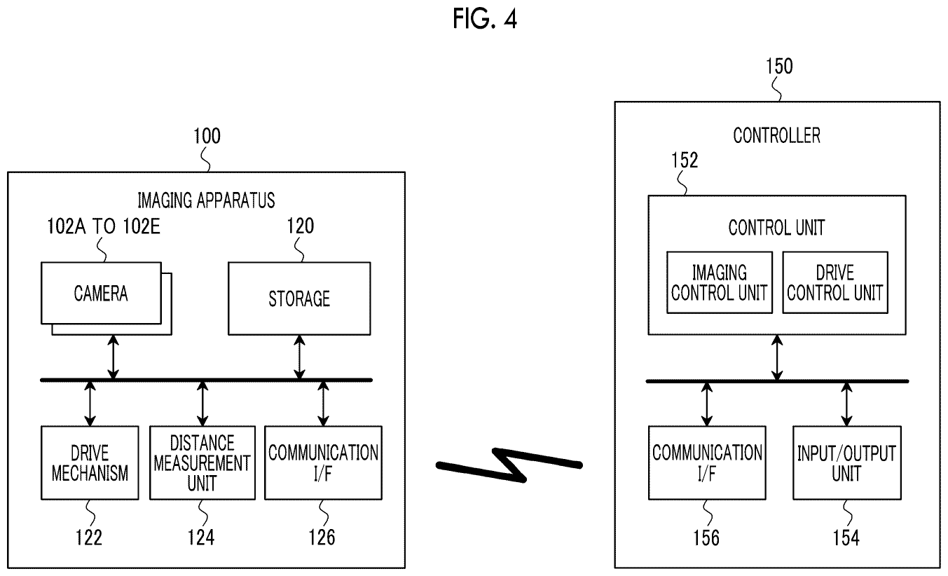

FIG. 4 is a block diagram of the imaging apparatus 100. As shown in FIG. 4, the imaging apparatus 100 can perform control of movement and imaging by using a controller 150.

The imaging apparatus 100 includes the cameras 102A to 102E, a storage 120, a drive mechanism 122, a distance measurement unit 124, and a communication I/F 126.

The storage 120 stores the individual images P captured by the cameras 102A to 102E. For example, a device including a magnetic disk such as an HDD, a device including a flash memory such as an eMMC or an SSD, or a recording medium (for example, SD memory card) that is attachable to and detachable from the imaging apparatus 100 can be used as the storage 14.

The communication I/F 126 is a device that performs communication with an external device including the image processing apparatus 1 and the controller 150. The individual images P captured by the cameras 102A to 102E may be transmitted to the image processing apparatus 1 via the communication I/F 126. Further, the individual images P may be input to the image processing apparatus 1 via the recording medium.

The drive mechanism 122 includes a motor for driving the carriage 106. In the imaging apparatus 100, the carriage 106 is moved by the drive mechanism 122 in the tunnel in accordance with a driving control signal from the controller 150.

The distance measurement unit 124 is a device that measures a distance to a subject. For example, a time of flight (TOF) type device that measures the distance to the subject using measurement light, such as laser light or infrared light, can be used as the distance measurement unit 124. The distance measurement unit 124 can be omitted.

As shown in FIG. 2, in a case where the plurality of cameras 102A to 102E are mounted on the carriage 106, it is preferable that the distance measurement unit 124 rotates the measurement light along the disposition of the cameras 102A to 102E to measure a distance around the entire periphery of the inner peripheral surface of the tunnel. In a case where the inner peripheral surface of the tunnel is imaged by the cameras 102A to 102E, in a process of the movement of the carriage 106, a distance to an imaged wall surface changes by a threshold value or more for some cameras, and the distance does not change for some cameras. In this case, in a case where the distance to the wall surface of the captured image changes by the threshold value or more even for one camera, the carriage 106 is stopped, an imaging condition is changed, then the carriage is moved backward, and the imaging is resumed. For the camera in which the distance to the imaged wall surface does not change by the threshold value or more, it is not necessary to change the imaging condition or to image the same divided region twice.

The controller 150 includes a control unit 152, an input/output unit 154, and a communication I/F 156.

The control unit 152 includes a processor (for example, CPU) for controlling the imaging apparatus 100 and a memory (for example, read only memory (ROM) in which a control program is stored and RAM serving as a work area of the processor). The control unit 152 performs imaging control of the cameras 102A to 102E and drive control of the carriage 106 and the drive mechanism 122 in accordance with an input from the input/output unit 154.

The input/output unit 154 includes an input device that receives the instruction input from the user, and a display device that displays the image or the GUI.

The communication I/F 156 is a device that performs communication with an external device including the imaging apparatus 100.

In the example shown in FIG. 4, the controller 150 is separated from the imaging apparatus 100 and can remotely operate the imaging apparatus 100, but the present invention is not limited thereto. The controller 150 may be integrated with, for example, the imaging apparatus 100. Further, the carriage 106 of the imaging apparatus 100 is moved by the drive mechanism 122, but the carriage 106 may be moved manually without providing the drive mechanism 122. Further, the image processing apparatus 1 may also serve as the controller 150 of the imaging apparatus 100.

### Image Processing Function

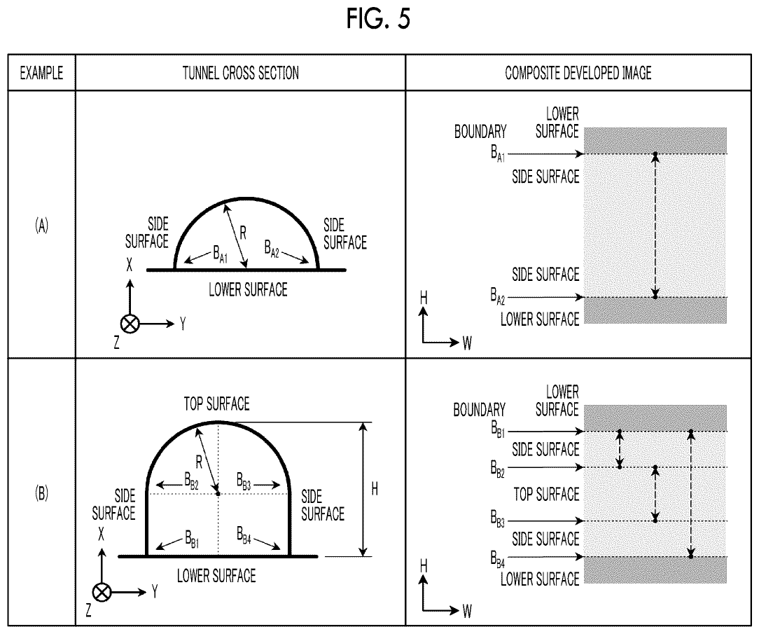

As shown in FIG. 5, the image processing apparatus 1 according to the present embodiment connects or combines the individual images P of the inner peripheral surface of the tunnel, which are captured by the cameras 102A to 102E, along the inner peripheral direction and the depth direction of the tunnel to create a composite image (composite developed image), and outputs the composite image to the display unit 22. The user can observe, detect, and measure damage on the inner peripheral surface of the tunnel by using the display (GUI) of the composite image.

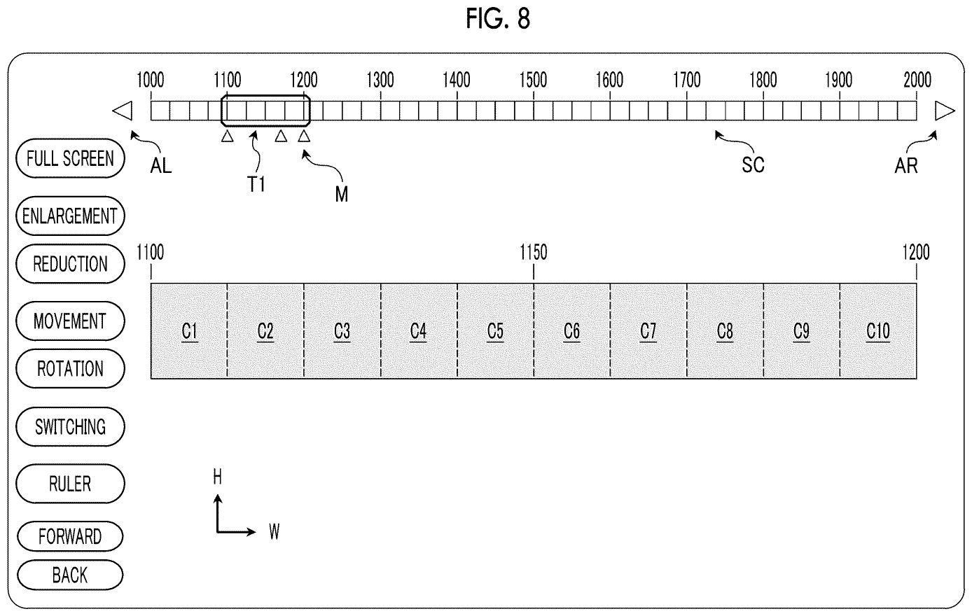

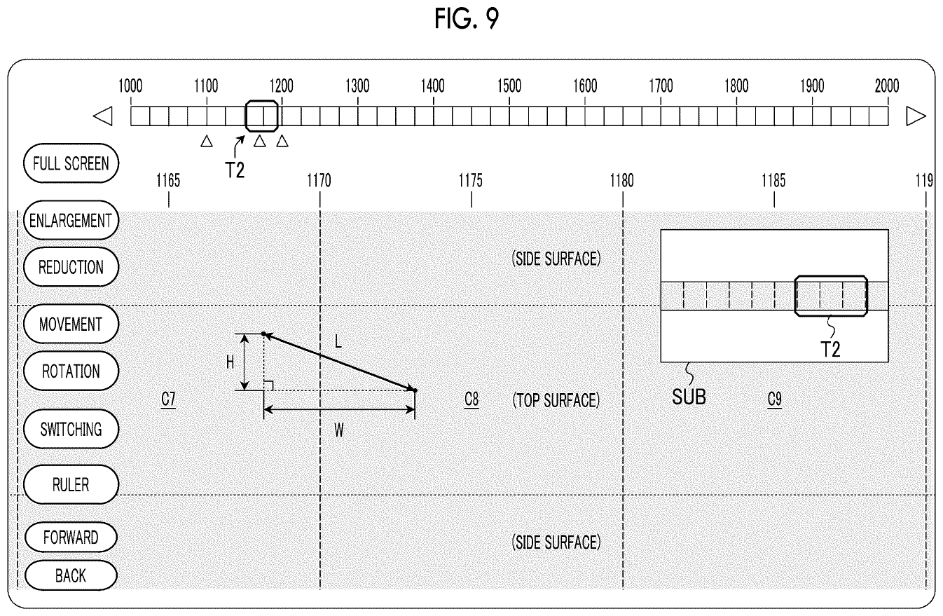

Incidentally, in practice, the expression of the entire region of the structure with one composite image may not be suitable for the inspection of the structure. For example, in a case where a size of the damage to be detected is smaller than a size of the region included in one composite image, it is considered to be difficult for the user to find the damage from the display of the composite image. In the present embodiment, each composite range that includes a plurality of divided regions and is set for the display and the observation is set for the structure. A composite image is created using a plurality of image sets (image sets each including a plurality of individual images P) corresponding to each composite range, and a plurality of composite images are displayed side by side (refer to FIGS. 8 and 9).

FIGS. 5 to 7 are diagrams for describing an image processing function of the image processing apparatus 1. In the following, a tunnel that has a substantially semicircular shape (Example A) and a tunnel that has a side surface in a straight line (plane) and a substantially semicircular-shaped top surface (arch) (Example B) will be described, but the image processing function according to the present embodiment can be applied to a tunnel having any shape.

The image processing apparatus 1 uses a combining processing function of the processor 10 to combine the individual images P of the inner peripheral surface of the tunnel, which are captured by the cameras 102A to 102E, by a predetermined composite range. In the examples shown below, the composite range is set to the entire periphery of the tunnel in the inner peripheral direction and a predetermined distance (for example, 10 m) in the depth direction. With the resizing processing of the composite image, it is possible to comprehensively observe, detect, and measure the damage on the inner peripheral surface of the tunnel by using the composite image for each composite range.

A size, an aspect ratio, and the like of the composition range may be automatically set by the processor 10 or may be set by the user, in accordance with the display unit 22 as an output destination or the like.

The composite image in which the individual images P are combined includes an image of the side surface, or the side surface and the top surface (entire periphery), and an image of a part of a lower surface (road surface). The processor 10 extracts at least two points from the composite image.

In the example shown in FIG. 5, in Example A, for example, at least two points (for example, pixel positions of two points) on boundaries B_{A1} and B_{A2} between the side surface and the lower surface are extracted. Further, in Example B, at least two points (for example, pixel positions of two points) on boundaries B_{B1} and B_{B4} between the side surface and the lower surface and boundaries B_{B2} and B_{B3} between the side surface and the top surface are extracted.

In Example B, in a case where a height of the side surface is not high (for example, in a case where (H−R)/H is equal to or less than a threshold value as compared with a height H of the tunnel), only the points on the boundaries B_{B1} and B_{B4} between the side surface and the lower surface may be extracted.

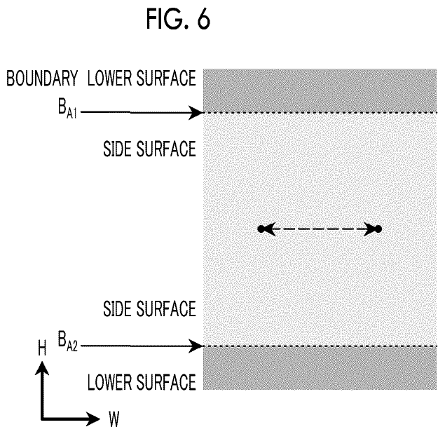

Further, the number of points extracted from the composite image is not limited to two points, and the points do not need to be distributed in a peripheral direction (H direction). For example, the points may be distributed in a depth direction (W direction) or may be distributed in an oblique direction, as shown in FIG. 6. Further, the points to be extracted from the composite image are not limited to the points on the above boundaries (B_{A1}, B_{A2}, and B_{B1} to B_{B4}). For example, as shown in FIG. 6, the points may be two points serving as some kind of mark (for example, a feature pattern on the inner peripheral surface, an accessory such as a cable or illumination, or a mark (chalk) put on the inner peripheral surface of the tunnel during inspection).

Next, the processor 10 acquires, from the subject information DB 200, subject information D related to the structure OBJ (tunnel) of the subject. The subject information D includes, for example, data related to design information of the tunnel (for example, including data indicating a size, a shape, and the like) or drawing data (computer aided design (CAD)). The processor 10 acquires, from the subject information D, a length (distance) between the extracted two points.

The length between the extracted two points may be calculated from a dimension on the drawing using an estimation equation as follows. For example, a distance (tunnel perimeter) between the two points on the boundaries B_{A1} and B_{A2} of Example A is obtained by Equation (1).

$$Tunnel perimeter = length of upper semicircular arc = π R \qquad ( 1 )$$

Further, a distance (tunnel perimeter) between the two points on the boundaries B_{B1} and B_{B4} of Example B is obtained by Equation (2).

$$Tunnel perimeter = upper semicircular arc + side surface height \times 2 = π R + 2 ( H - R ) \qquad ( 2 )$$

Further, for the length between the extracted two points, the user may input a length (measurement value in the field, or the like) through the operation unit 20.

Next, the processor 10 performs the resizing processing such that the composite image approaches or matches a desired pixel spacing (target value). The pixel spacing (mm/pixel) is a parameter indicating a length or a distance of a subject indicated by pixels included in an image. The processor 10 may set a value of the desired pixel spacing based on the instruction input from the user through the operation unit 20.

Further, the value of the desired pixel spacing may be set based on pixel spacing information for each of the individual images P constituting the composite image. Specifically, the processor 10 acquires meta information (for example, exchangeable image file format (Exif) tag information) embedded in an image file of the individual image P, or the pixel spacing information recorded in association with (linked to) the image file of the individual image P. The processor 10 sets the pixel spacing of the composite image based on the pixel spacing information of the individual image P. The individual images P constituting the composite image are set to, for example, a representative value of the pixel spacing information, more specifically, an average value, a minimum value, a median value, or a maximum value.

Incidentally, in a case where the resizing processing is performed on the composite image in a direction in which the number of pixels decreases or in a direction in which the value of the pixel spacing increases (referred to as direction in which the number of pixels decreases), an amount of information included in the image is decreased. For this reason, it is desirable that the desired pixel spacing is set to the minimum value of the pixel spacing of the individual images P constituting the composite image (set to a value having the highest spatial resolution).

Further, the value of the desired pixel spacing may be set based on other information, without being based on the pixel spacing information of the individual image P. For example, the value of the desired pixel spacing may be calculated by the following Equation (3), using a distance to the subject (inner peripheral surface of the tunnel or position of a point where the camera (102A to 102E) is focused on the inner peripheral surface thereof) of D (mm), a focal length of the camera (102A to 102E) of F (mm), a size of the imaging element (lateral or longitudinal sensor size) of S (mm), and the number of (lateral or longitudinal) pixels of the imaging element of P (pixel). In a case where the distance to the subject is measured at the same time as the imaging, the pixel spacing may be obtained by using this equation.

$$Pixel spacing ( mm / pixel ) = imaging range ( mm ) / number of pixels ( pixel ) = ( D \times S / F ) / P \qquad ( 3 )$$

Next, the processor 10 sets the desired pixel spacing, and then performs the resizing processing on the composite image such that the composite image approaches or matches the desired pixel spacing. The resizing processing may be performed on the entire composite image, may be performed for each region in the composite image (for example, each top surface or each side surface), or may be performed for each of the individual images P.

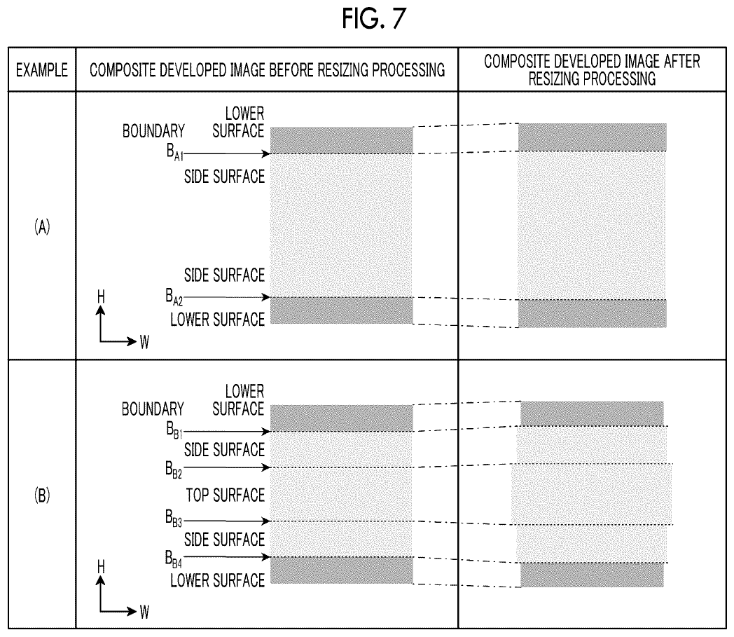

In Example A of FIG. 7 (upper part), the resizing processing is performed on the entire composite image. In a case where the tunnel perimeter (actual length) is 10,000 mm and the desired pixel spacing is 0.5 mm/pixel, a target size (number of pixels) of the composite image is 10,000/0.5=20,000 pixels. In a case where the number of pixels of an original composite image before the resizing processing is 19,048 pixels, the number of pixels is approximately 1.05 times (20,000 pixels/19,048 pixels) the original number of pixels.

In a case where the image is reduced by the resizing processing, the amount of information included in the image is reduced. Thus, in a case where a resizing magnification is out of a predetermined allowable range (for example, in a case where the resizing magnification is less than 0.9), it is desirable to issue a warning to prompt the user to check.

Example B (lower part) of FIG. 7 shows an example in which the resizing processing is performed for each region in the composite image. In the above example, the resizing processing is performed for respective individual regions in the composite image such that the respective individual regions have the desired pixel spacing, and images of the respective individual regions after the resizing processing are combined (integrated).

For example, different resizing processing may be performed for each top surface region and each side surface region such that the top surface and the side surface of the tunnel each have the desired pixel spacing. In this case, unevenness may occur in the depth direction on the composite image, as shown in the lower part of FIG. 7. Since a convex portion of the composite image may include a portion that partially overlaps with an adjacent composite image, trimming processing of excluding the convex portion may be performed, or the composite image may be shaped into a rectangle.

FIGS. 8 and 9 are diagrams showing display examples (including GUI) of composite images (composite developed images). FIG. 8 shows an example in which ten composite images C1 to C10 in which a length of the tunnel in the depth direction is 10 m are displayed side by side in a lateral direction. FIG. 9 shows an example in which the composite images are displayed in an enlarged manner.

A scale SC indicating the length of the tunnel in the depth direction (W direction) is provided on upper parts of screens of FIGS. 8 and 9. A unit of numerical values attached to the scale SC is 10 mm.

Scroll buttons AL and AR are each provided at both left and right ends of the scale SC. The scroll buttons AL and AR are operated by using the operation unit 20 to enable display of images of the entire range of the tunnel in the depth direction.

A frame T1 indicating a range of the composite images displayed at the center of the screen is displayed on the scale SC. In FIG. 8, since the depth direction is 10 m, the frame T1 is displayed at positions of 1100 to 1200. The frame T1 is operated (moved and changed in size) by using the operation unit 20 to enable a change in a display range displayed at the center of the screen. The size of the frame T1 may be changeable in both the W direction and the H direction.

A reference numeral M in the drawing is a marker indicating a position of a subject (for example, damage) satisfying a predetermined condition.

A display size of the composite images C1 to C10 can be changed by enlargement and reduction buttons in the drawing. In the example shown in FIG. 9, the composite images C7 to C9 are displayed in an enlarged manner, and a width of a frame T2 of the scale SC in the W direction is reduced accordingly.

A reference numeral SUB in the drawing is a sub screen corresponding to the display before the enlargement. In the sub screen SUB, the frame T2 is displayed at positions corresponding to the frame T2 (corresponding to the composite images C7 to C9).

As described above, the pixel spacings of the composite images C1 to C10 are equal to each other by the resizing processing. Therefore, with the designation of the two points on the composite images C1 to C10 using the operation unit 20, it is possible to measure a length between two points. Accordingly, for example, it is possible to measure a length, width, and height of a desired target (for example, damage such as fissuring, liberating lime, peeling, or corrosion) that appears in the composite image. For example, in FIG. 9, it is possible to measure a length L between two points, a length (width) W in the depth direction of the two points, and a length (height) H in a vertical direction (peripheral direction). In the example shown in FIG. 9, L=4.85 m, W=4.5 m, and H=1.8 m.

According to the present embodiment, with the resizing processing on the composite images C1 to C10, it is possible to perform the display suitable for the comprehensive evaluation of the damage.

### Image Processing Method

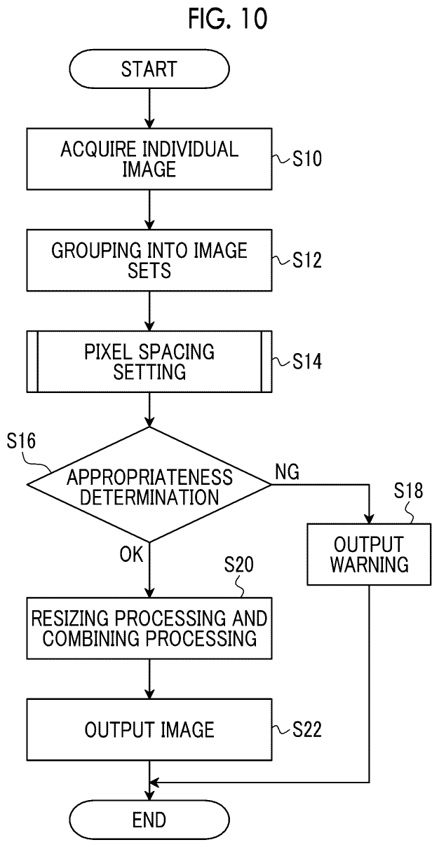

FIG. 10 is a flowchart showing the image processing method according to an embodiment of the present invention.

First, the processor 10 acquires the individual images P from the imaging apparatus 100 (step S10), and groups the individual images P into the image sets of the individual images P corresponding to the composite range (step S12).

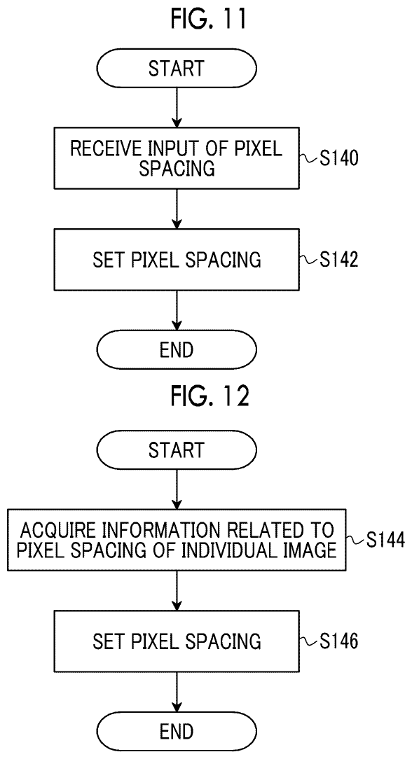

Next, the pixel spacing is set (step S14). In step S14, as shown in FIG. 11, an input of the pixel spacing may be received from the operation unit 20 (step S140), and the pixel spacing may be set according to the input (step S142). Further, as shown in FIG. 12, the processor 10 may acquire information related to the pixel spacing of the individual image P (step S144), and set the pixel spacing based on the information related to the pixel spacing (step S146).

Next, appropriateness of the pixel spacing set in step S14 is determined (step S16), and a warning is output by the display unit 22, a speaker (not shown), or the like in a case where the appropriateness determination is NG (step S18). In step S14, the warning may be output in a case where the resizing magnification in the resizing processing is out of the allowable range, or the warning may be output in a case where the image set includes an individual image having the pixel spacing larger than the desired pixel spacing.

In a case where the appropriateness determination (step S14) is OK, the processor 10 performs the resizing processing and combining processing of the composite image (step S20). In step S20, the resizing processing may be performed on the composite image in which the individual images P are combined, or the combining processing may be performed after the resizing processing on the individual images P is performed. Further, the resizing processing may be performed for each portion of the composite image in which the individual images P are combined.

The composite image created as described above is output to the display unit 22, and the user can perform the inspection and the like of the damage with reference to the display (refer to FIGS. 8 and 9).

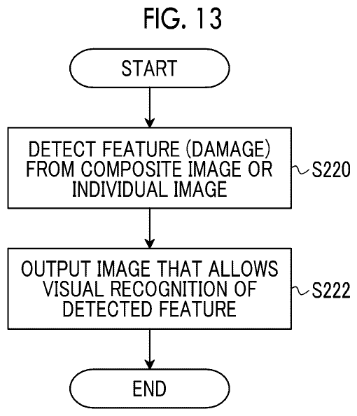

As shown in FIG. 13, in an image output step, the processor 10 may detect a predetermined feature of the subject (for example, damage such as fissuring, liberating lime, peeling, or corrosion), based on a feature amount such as brightness or color of the composite image or the individual image P or based on machine learning, pattern matching, or the like (step S220). The processor 10 may draw an image (for example, marking or coloring) that allows the user to visually recognize a detection result of the feature detected in step S220, and may output the image to the display unit 22 (step S222). In step S222, the composite image and the drawing of the detection result may be displayed together (for example, side by side or in superimposed manner), or the composite image and the drawing of the detection result may be displayed in a switchable manner.

### MODIFICATION EXAMPLE

In the above embodiment, an example has been described in which the image processing apparatus 1 is applied to a general-purpose computer or a tablet terminal, but the present invention is not limited thereto. For example, the image processing function according to the above embodiment may be realized by a cloud server. That is, the image processing function according to the above embodiment may be provided as software as a service (SaaS). In this case, the individual image P and the subject information D may be uploaded to the cloud server via a terminal including the operation unit 20 and the display unit 22 (for example, tablet terminal), and an operation input may be performed to cause the image processing apparatus 1 included in the cloud server to perform the image processing. Further, the subject information DB 200 may be included in the cloud server.

Further, the type of the structure OBJ is not limited to the tunnel. For example, it is possible to apply the image processing according to the above embodiment to the inspection of structures other than the tunnel, such as bridges, roads, and dams. In the imaging apparatus 100, it is possible to change the disposition of the cameras (102A to 102E) in accordance with the structure, shape, size, and the like of the structure OBJ. For the drive mechanism 122 of the imaging apparatus 100, any appropriate mechanism, for example, unmanned aircraft, such as a multicopter or a drone, or a moving object, such as a vehicle or a robot, can be applied according to the structure, shape, size, and the like of the structure OBJ.

### EXPLANATION OF REFERENCES

1: image processing apparatus
10: processor
12: memory
14: storage
16: communication I/F
20: operation unit
22: display unit
100: imaging apparatus
102A to 102E: camera
104: camera attachment member
106: carriage
120: storage
122: drive mechanism
124: distance measurement unit
126: communication I/F
150: controller
152: control unit
154: input/output unit
156: communication I/F
200: subject information DB

What is claimed is:

1. An image processing apparatus comprising:
a processor,
wherein the processor is configured to:
acquire pixel positions of at least two points of a plurality of individual images obtained by imaging a subject or a composite image obtained by combining the individual images, and an actual length between the two points; and
perform resizing processing on the individual image or the composite image such that the number of pixels between the two points approaches a desired pixel spacing.

2. The image processing apparatus according to claim 1,
wherein the two points are on boundaries between different surfaces that constitute the subject.

3. The image processing apparatus according to claim 1,
wherein the processor is configured to:
designate the two points in response to an instruction input from a user.

4. The image processing apparatus according to claim 1,
wherein the processor is configured to:
acquire the actual length between the two points from drawing data of the subject.

5. The image processing apparatus according to claim 1,
wherein the processor is configured to:
acquire the actual length between the two points from information indicating a shape and a dimension of the subject.

6. The image processing apparatus according to claim 1,
wherein the processor is configured to:
divide the plurality of individual images into a plurality of image sets;
combine the plurality of image sets to create a plurality of composite images; and
perform the resizing processing on the plurality of composite images such that pixel spacings of the plurality of composite images approach the desired pixel spacing.

7. The image processing apparatus according to claim 6,
wherein the processor is configured to:
display the plurality of composite images side by side on a display unit.

8. The image processing apparatus according to claim 1,
wherein the processor is configured to:
detect damage to the subject from the individual image or the composite image; and
draw a detection result of the damage together with the composite image.

9. The image processing apparatus according to claim 8,
wherein the processor is configured to:
display the composite image and the composite image on which the detection result of the damage is drawn, on a display unit, in a switchable manner.

10. The image processing apparatus according to claim 1,
wherein the processor is configured to:
designate a pixel spacing of the individual image or the composite image, which has been subjected to the resizing processing, in response to an instruction input from a user.

11. The image processing apparatus according to claim 1,
wherein the processor is configured to:
designate a pixel spacing of the individual image or the composite image, which has been subjected to the resizing processing, based on information related to a pixel spacing of the individual image.

12. The image processing apparatus according to claim 11,
wherein the processor is configured to:
designate a pixel spacing of the composite image, which has been subjected to the resizing processing, based on at least one of a representative value, an average value, a maximum value, or a minimum value of the pixel spacing of the individual image.

13. The image processing apparatus according to claim 1,
wherein the processor is configured to:
output a warning in a case where a resizing magnification in the resizing processing is out of an allowable range.

14. The image processing apparatus according to claim 1,
wherein the processor is configured to:
output a warning in a case where there is the individual image having a pixel spacing that is larger than the desired pixel spacing.

15. The image processing apparatus according to claim 1,
wherein the individual image is obtained by imaging at least a part of a top surface, a side surface, or a lower surface of a tunnel as the subject.

16. An image processing method using an image processing apparatus including a processor, the image processing method by the processor comprising:
a step of acquiring pixel positions of at least two points of a plurality of individual images obtained by imaging a subject or a composite image obtained by combining the individual images, and an actual length between the two points; and
a step of performing resizing processing on the individual image or the composite image such that the number of pixels between the two points approaches a desired pixel spacing.

17. A non-transitory, computer-readable tangible recording medium on which a program for causing a computer to execute the image processing method according to claim 16 is recorded.
